(19) United States
(12) Patent Application Publication
(10) Pub. No.: US 2021/0289805 A1
(43) Pub. Date: Sep. 23, 2021

(54) VEGAN CHEESE

(71) Applicant: Clo Clo Vegan Foods, LLC, Edina, MN (US)

(72) Inventors: Augie Hinnenkamp, Edina, MN (US); Robert Victor Velarde, Crystal, MN (US)

(21) Appl. No.: 17/208,823

(22) Filed: Mar. 22, 2021

Related U.S. Application Data
(60) Provisional application No. 62/992,714, filed on Mar. 20, 2020.

(51) Int. Cl. A23C 20/02; A21D 13/41

(52) U.S. Cl. CPC A23C 20/025; A23L 29/20; A21D 13/41

(57) ABSTRACT

The present disclosure relates to a vegan cheese and products thereof. The vegan cheese comprises one or more plant milks, preferably an oat milk or a pea milk; and optionally one or more vegetables derived from Brassica, preferably cauliflower. The vegan cheese may further comprise starch, plant oil, and additional ingredients. The vegan cheese is free or substantially free from animal products. The methods of making the vegan cheese are provided. Food products such as pizza containing the vegan cheese are also described.

### CROSS-REFERENCE TO RELATED APPLICATION

This application claims the benefit of U.S. Provisional Application No. 62/992,714, filed Mar. 20, 2020, the disclosure of which is hereby incorporated by reference.

### BACKGROUND

Cheese is an important food staple, but dairy-based foods are a problem for consumers with sensitivities or allergies to animal-based dairy products. There is a need for dairy-free, cheese analogue food products that avoid dairy sensitivities and allergies. While dairy-free cheese analogue products made from nut-based milks avoid problems with animal-based dairy products, they introduce a nut allergy. Further, a number of dairy-free cheese analogue food products lack the desired texture, consistency, performance, or taste of traditional cheese and are limited in possible uses as shredded cheese or in cooking. There remains a need for a cheese analogue that does not create a food allergy or sensitivity problem and still tastes and performs like traditional cheese.

### SUMMARY OF THE DISCLOSURE

In some aspects, the present disclosure relates to a vegan cheese comprising one or more plant milks, preferably an oat milk, or a pea milk; one or more vegetables derived from Brassica, Brassica oleracea, or Brassicaceae, preferably cauliflower; and water, wherein the vegan cheese is substantially free from animal products. In some embodiments, the plant milk is in a range from about 3 wt. % to about 20 wt. %, or from about 5 wt. % to about 15 wt. %, or from about 7 wt. % to about 12 wt. %, based on the total weight of the vegan cheese. In some embodiments, the cauliflower is in a range from about 0.1 wt. % to about 5 wt. %, or from about 0.5 wt. % to about 3 wt. %, or from about 1 wt. % to about 2 wt. %, based on the total weight of the vegan cheese. In some embodiments, water is in a range from about 20 wt. % to about 50 wt. %, or from about 25 wt. % to about 45 wt. %, or from about 30 wt. % to about 40 wt. %.

The vegan cheese of the present disclosure may further comprise one or more starches selected from the group of corn starch, wheat starch, maize starch, cassava starch, tapioca starch, rice starch, potato starch, sweet potato starch, pea starch, or combinations thereof. In some embodiments, the total content of starches in the present vegan cheese is in a range from about 10 wt. % to about 50 wt. %.

The vegan cheese of the present disclosure may further comprise one or more plant/vegetable oils. In some embodiments, the total content of the plant/vegetable oils is in a range from about 5 wt. % to about 35 wt. %.

The vegan cheese of the present disclosure may further comprise one or more additional ingredients selected from the group of an acidity regulator, an acid, an anticaking agent, an antifoaming agent, a coloring agent, an emulsifier, an enzyme or enzyme preparation, a flavoring agent, a spice, a gelling agent, a preservative, a thickener, a stabilizer, a gum, a salt, a nutritional supplement, a nutritional yeast, a nutraceutical, a juice, a carbohydrate, a vitamin or vitamin concentrate, a mineral, or combinations thereof. In some embodiments, the vegan cheese comprises from about 0.1 wt. % to about 2 wt. % of xanthan gum. In some embodiments, the vegan cheese comprises from about 0.2 wt. % to about 3 wt. % of carrageenan. In some embodiments, the vegan cheese comprises from about from about 0.1 wt. % to about 2 wt. % of a lemon juice. In some embodiments, the vegan cheese comprises from about from about 0.1 wt. % to about 1 wt. % of a nutritional yeast. In some embodiments, the vegan cheese comprises from about 0.5 wt. % to about 5 wt. % of salt. In some embodiments, the vegan cheese comprises one or more coloring agents, wherein the one or more coloring agents comprise from about 0.1 wt. % to about 0.5 wt. % of annatto and beta-carotene. In some embodiments, the vegan cheese comprises from about 0.01 wt. % to about 0.1 wt. % of a spice, wherein the spice is selected from the group of paprika, turmeric, ginger, pepper, garlic, onion, cardamom, cumin, clove, fennel, fenugreek, nutmeg, mace, rosemary, anise, thyme, mustard, ajwain, cinnamon, or combinations thereof.

In some embodiments, the vegan cheese of the present disclosure is substantially free from genetically-modified organisms (GMOs) or part thereof.

In some embodiments, the vegan cheese of the present disclosure is free from an allergen, wherein the allergen is selected from the group of dairy milk, egg, fish, crustacean, shellfish, nut, tree nut, peanut, soybean, and gluten.

In some aspects, the present disclosure relates to a method of making the vegan cheese. In some embodiments, the method comprises: (a) cooking a mixture of water and one or more plant milks at a temperature of about 30° C. to about 70° C., about 40° C. to about 60° C., or about 45° C. to about 55° C.; (b) adding to the mixture one or more vegetables derived from Brassica, Brassica oleracea, or Brassicaceae with agitation; (c) cooking the mixture at a temperature of about 70 to about 100° C., or from about 80° C. to about 90° C., or from about 82° C. to about 88° C.; (d) cooling the mixture and letting it rest for at least about 5 days, at least about 7 days, at least about 10 days, at least about 12 days, at least about 14 days, or at least about 16 days, or from about 5 days to about 21 days, from about 6 days to about 15 days, from about 7 days to about 14 days, from about 8 days to about 12 days, or from about 9 days to about 11 days. In some embodiments, the method may further comprise adding one or more plant/vegetable oils in step (a). In some embodiments, the method may further comprise adding salt, one or more thickeners/stabilizers, and nutritional yeast in step (b). In some embodiments, the method may further comprise adding to the mixture a juice and natural vegan flavor with agitation between step (b) and (c). In some embodiments, the method may further comprise adding to the mixture one or more starches with agitation between step (b) and (c). In some embodiments, the method may further comprise adding to the mixture one or more additional ingredients according to the present disclosure.

In some aspects, the vegan cheese of the present disclosure relates to a cheese analogue made from the present vegan cheese, wherein the cheese analogue simulates cream cheese, Mozzarella cheese, Cheddar cheese, Parmesan cheese (Parmigiano-Reggiano cheese), Swiss cheese, Gruyère cheese, Feta cheese, Gouda cheese, Manchego cheese, Pecorino cheese, Brie cheese, Habanero cheese, jack cheese, or Pepper Jack cheese.

In some aspects, the vegan cheese of the present disclosure relates to a cheese product containing the present vegan cheese, wherein the cheese product is aligot, almogrote, burrito, taco, pizza, pizza analogue, pasta, lasagna, sandwich, burger, croque monsieur, cheeseburger, gratin, fondue, hot dog, waffle, sandwich, wrap, baked cheese, tortilla chip, cheese sauce, cheese bite, cheese condiment, cheese crisp, bagel and cream cheese, cheese soup, cheese salad, cheese and crackers, cheese bun, cheese dog, cheese fries, cheese toastie, cheese pudding, cheese puffs, cheese roll, cheese slaw, cheesecake, frico, fried cheese, cheese and fries, cheese pie, fromage fort, lasagna, macaroni and cheese, cheese sausage, nachos, quesadilla, quesillo, quesito, raclette, rasabali, saganaki, or ziva.

In some embodiments, the present cheese product is a pizza. In some embodiments, the pizza is substantially free from animal products. In some embodiments, the present pizza further comprising a dough, a crust, one or more sauces, and one or more toppings. In some embodiments, the present pizza further comprises one or more ingredients selected from the group of oil, sweetener, flavoring agent, food additives, or combinations thereof. The present pizza may be uncooked, semi-finished, cooked, frozen, heated or re-heated, or ready-to-serve. The present pizza may be microwavable.

### DETAILED DESCRIPTION

### Vegan Cheese Composition

In some aspects, the present disclosure relates to a vegan cheese comprising one or more plant milks, preferably an oat milk or a pea milk; one or more vegetables derived from Brassica, Brassica oleracea, or Brassicaceae, preferably cauliflower; and water, wherein the vegan cheese is substantially free from animal products.

Plant milk, as opposed to dairy milk, is not an animal product. Plant milk is derived from vegetation and therefore is free from dairy sources. The plant milk used in the present vegan cheese may be derived from whole grains. A whole grain is a grain of any cereal and pseudocereal that contains the endosperm, germ, and bran. Whole grains include but not are limited to wheat, rice, barley, maize, rye, oats, millets, sorghum, teff, triticale, canary grass, fonio, amaranth, buckwheat, quinoa, and wild rice.

In preferred embodiments, the plant milk of the present vegan cheese is an oat milk. Oat (Avena sativa) is a species of cereal grain grown for its seed. Oat is known as a nutrient-rich source associated with lower blood cholesterol when consumed regularly. Oat milk is distinguishable from nut milk. In particular, oat milk is free of many of the allergens including nuts and gluten. Oat milk also contains beta-glucans, a soluble fiber that may offer heart health benefits. Oat milk has low fat and is an excellent choice for the lactose intolerant consumers. Oat milk is high in vitamins, high in unsaturated fats, high in bone-strengthening minerals, and free from cholesterol. Oat milk can provide sweet taste and regulate blood sugar levels. Additionally, oat milk replicates the viscosity of dairy milk more closely than other alternative milks do and simulates regular dairy milk with respect to meltability and stretchability. When integrated into the present vegan cheese, oat milk advantageously imparts a toasted-grain flavor that seamlessly blends with other flavors, providing a unique taste that enhances the palatability. Oat milk is usually made according to a standard process in the food industry. Production of oat milk may start with milling, followed by enzyming to break down the oat starches into smaller components. The bran is then separated from the oats, leaving behind the loose fibers. Then, optional nutritional supplements and/or ingredients are added, such as vitamins. The oat milk is then sterilized before being packaged.

The plant milk used in the present vegan cheese may be also derived from peas. Pea is within the family of pod fruit Pisum sativum. Non-limiting examples of peas include green pea, golden pea, yellow pea, or purple pea. Pea milk contributes unique pea proteins to the vegan cheese. Examples of pea proteins are globulin, albumin, prolamin, glutelin, and legumin. Legumin has similar properties to casein (a dairy source) but is non-dairy in nature. Additionally, pea milk is usually enriched with vitamins, and can be a more environmentally-friendly alternative to nut milk and a non-GMO alternative to soy milk.

In some embodiments, the plant milk of the present vegan cheese is a blend of oat milk and pea milk.

In some embodiments, the plant milk is in a range from about 3 wt. % to about 50 wt. %, or from about 5 wt. % to about 40 wt. %, or from about 5 wt. % to about 30 wt. %, or from about 5 wt. % to about 20 wt. %, or from about 5 wt. % to about 15%, or from about 7 wt. % to about 12 wt. %, based on the total weight of the vegan cheese.

In some embodiments, the present vegan cheese is free or substantially free from milks derived from nuts or tree nuts. Examples of nuts and tree nuts include peanuts, almonds, Brazil nuts, cashews, chestnuts, filberts/hazelnuts, macadamia nuts, pecans, pistachios, shea nuts, and walnuts.

In some embodiments, the present vegan cheese is free or substantially free from soy milk or milks derived from soybeans.

In preferred embodiments, the present vegan cheese comprises cauliflower. Cauliflower is a species within the family of Brassica, Brassica oleracea, or Brassicaceae. Cauliflower is a cruciferous vegetable that is naturally high in fiber and B-vitamins. It provides antioxidants and phytonutrients that can protect against cancer. It also contains fiber to enhance weight loss and digestion, choline that is essential for learning and memory, and many other important nutrients. Importantly, cauliflower has a light color that is favorably compatible with the oat milk and other sources, resulting in vegan cheeses that are appealing in appearance. Unlike traditional ingredients such as rice, which tends to be insipid and thin, cauliflower is savory, and delivers a stronger building block for the present vegan cheese with its fiber for set up and curing times. In some embodiments, the present vegan cheese has a content of cauliflower from about 0.1 wt. % to about 5 wt. %, or preferably from about 1 wt. % to about 3 wt. %, or more preferably from about 1.4 wt. % to about 2 wt. %, based on the total weight of the vegan cheese. In some embodiments, the present vegan cheese is free of cauliflower.

The cauliflower used in the present vegan cheese may be in any possible form such as frozen cauliflower, soaked cauliflower, dry solid, powder, slurry, puree, etc. In preferred embodiments, the present vegan cheese comprises cauliflower puree, paste, or mash. As a non-limiting example, frozen cauliflower is mixed with water, blended, ground, pressed, or sieved into a consistency of paste containing fine particles of cauliflower. The cauliflower paste when blended with plant milk and other sources tends to produce a homogeneous vegan cheese in color, texture, and appearance.

In some embodiments, water of the present vegan cheese is in a range from about 20 wt. % to about 50 wt. %, or from about 25 wt. % to about 45 wt. %, or from about 30 wt. % to about 40 wt. %, based on the total weight of the vegan cheese.

The vegan cheese of the present disclosure may further comprise one or more starches. Starch or amylum is a polymeric carbohydrate consisting of numerous glucose units joined by glycoside bonds. The starch can be a natural starch or a modified starch, including but not limited to corn starch, wheat starch, maize starch, cassava starch, tapioca starch, rice starch, potato starch, sweet potato starch, pea starch, or combinations thereof In particular, modified starch is the starch extracted from grains and vegetables, which have been treated to improve its ability to keep the texture and structure of the food. Starches may be advantageous because they can contribute to the cheese body and texture, introducing necessary carbohydrates, as well as providing other functional and nutritional attributes. In some embodiments, the present vegan cheese comprises at least a corn starch and a tapioca starch, wherein the total content of starches is in a range from about 10 wt. % to about 50 wt. %, about 20 wt. % to about 40 wt. %, or about 25 wt. % to about 35 wt. %, based on the total weight of the vegan cheese.

The vegan cheese of the present disclosure may further comprise one or more plant/vegetable oils. A vegetable oil is an extract from a plant or the seeds thereof. The term “vegetable oil” is broadly defined without regard to a substance's state of matter at a given temperature. Vegetable oil is an important source of non-animal fat in the present vegan cheese. Non-limiting examples of plant oils include corn oil, olive oil, sesame oil, cottonseed oil, rapeseed oil, canola oil, safflower oil, sunflower oil, flax seed oil, palm oil, palm kernel oil, coconut oil, babassu oil, shea butter, mango butter, wheat germ oil, or rice bran oil, or margarine.

Coconut oil, or copra oil, is an edible plant oil extracted from the kernel or meat of mature coconuts harvested from the coconut palm (Cocos nucifera). Coconut oil is a good source of medium-chain triglycerides (MCTs) and provides various health benefits, including improving cardiovascular health, increasing high-density lipoprotein (HDL), controlling blood sugar, reducing stress, etc. It is noted that coconut is botanically a fibrous one-seeded drupe (also known as a dry drupe), and is distinct from nut or tree nut. Therefore, the coconut oil used in the present vegan cheese is not a source of nut allergen. In some embodiments, the present vegan cheese comprises a coconut oil.

In some embodiments, the total content of the plant/vegetable oils is in a range from about 5 wt. % to about 35 wt. %, from about 10 wt. % to about 25 wt. %, or from about 15 wt. % to about 20 wt. %, based on the total weight of the vegan cheese.

The present vegan cheese may further comprise one or more additional ingredients selected from the group of an acidity regulator, an acid, an anticaking agent, an antifoaming agent, a coloring agent, an emulsifier, an enzyme or enzyme preparation, a flavoring agent, a spice, a gelling agent, a preservative, a thickener, a stabilizer, a salt, a nutritional supplement, a nutritional yeast, a nutraceutical, a juice, a carbohydrate, a vitamin or vitamin concentrate, a mineral, or combinations thereof.

A thickening agent or thickener can increase the viscosity of a liquid without substantially changing its other properties. Some thickening agents are gelling agents (gellants), forming a gel, dissolving in the liquid phase as a colloid mixture that forms a weakly cohesive internal structure. Stabilizers, like thickeners and gelling agents, give foods a firm texture or preserve the structure of foods without altering their taste. Thickeners, gelling agents, and stabilizers used in the present vegan cheese include but are not limited to alginate, alginic acid, agar, carrageenan, cellulose and cellulose derivatives, gelatin, gum, xanthan gum, guar gum, locus bean gum, polysaccharide, polypropylene glycol, konjac flour, etc.

Xanthan gum (CAS NO. 11138-66-2) is a polysaccharide. In some embodiments, the present vegan cheese comprises xanthan gum, wherein the xanthan gum is from about 0.1 wt. % to about 5 wt. %, or preferably from about 0.3 wt. % to about 3 wt. %, or more preferably from about 0.6 wt. % to about 2 wt. %, based on the total weight of the vegan cheese.

Carrageenans or carrageenins are a family of linear sulfated polysaccharides that are extracted from red edible seaweeds. In some embodiments, the present vegan cheese comprises carrageenan, wherein the carrageenan is from about 0.1 wt. % to about 5 wt. %, or preferably from about 0.5 wt. % to about 3 wt. %, or more preferably from about 1 wt. % to about 2 wt. %, based on the total weight of the vegan cheese.

In some embodiments, the present vegan cheese comprises salt (e.g., sodium chloride), wherein the salt is from about 0.5 wt. % to about 5 wt. %, or preferably from about 1 wt. % to about 4 wt. %, or more preferably from about 2 wt. % to about 3 wt. %, based on the total weight of the vegan cheese.

Juice is a consumable made from the extraction or pressing of the natural ingredients contained in fruits and vegetables. Juice used in the present vegan cheese introduces great nutritional elements like vitamin C, folic acid, potassium, carotenoids, polyphenols that offer health benefits. Many fruit juices contain fruit acids and can be used to adjust the pH of the vegan cheese composition during manufacturing. Juice additionally provides natural color, flavor and taste, making the vegan cheese more appealing to consumers. Non-limiting examples of juice include aloe vera juice, apple juice, beet juice, cantaloupe juice, carrot juice, celery juice, cherry juice, clam juice, cranberry juice, coconut water, cucumber juice, dandelion-green juice, fruit juice, grape juice, grapefruit juice, guava juice, honeydew juice, lime juice, kiwifruit juice, lemonade, limeade, lemon juice, kychee juice, melon juice, papaya juice, parsley juice, citrus juice, lemon juice, orange juice, pineapple juice, pomegranate juice, prune juice, raspberry juice, spinach juice, strawberry juice, sugarcane juice, tangerine juice, tomato juice, turnip juice, vegetable juice.

In some embodiments, the present vegan cheese comprises a lemon juice, wherein the content of the lemon juice is from about 0.1 wt. % to about 2 wt. %, or preferably from about 0.2 wt. % to about 1.2 wt. %, or more preferably from about 0.4 wt. % to about 0.6 wt. %, based on the total weight of the vegan cheese. The lemon juice comprises natural fruit acids such as citric acid and ascorbic acid (Vitamin C), and has a pH from about 1 to about 3. The lemon juice may effectively lower the pH of the vegan cheese to a desirable level below about 7. The lemon juice also increases the tartness level of the vegan cheese, providing a slightly tangy flavor that can be favored by customers.

Nutritional yeast is a deactivated yeast such as a strain of Saccharomyces cerevisiae. Nutritional yeast is a significant source of B-complex vitamins such as fortified vitamin B12 and contains trace amounts of other vitamins and minerals. In some embodiments, the present vegan cheese comprises a nutritional yeast, wherein the content of the nutritional yeast is from about 0.1 wt. % to about 1 wt. %, or preferably from about 0.2 wt. % to about 0.8 wt. %, or more preferably from about 0.4 wt. % to about 0.6 wt. %, based on the total weight of the vegan cheese.

In some embodiments, the present vegan cheese comprises a natural vegan flavor, wherein the content of the natural vegan flavor is from about 0.01 wt. % to about 0.6 wt. %, or preferably from about 0.05 wt. % to about 0.4 wt. %, or more preferably from about 0.1 wt. % to about 0.2 wt. %, based on the total weight of the vegan cheese. Natural vegan flavors are essentially various oil blends used to produce the flavors of meats and dairy products without actually using these ingredients. The natural vegan flavor used in the present vegan cheese can enhance the flavors of non-dairy ingredients therein and replicate the flavors of the common dairy cheeses. Non-limiting examples of the natural vegan flavors include SENSIENT® products from Sensient Technologies Co. such as Milky Mozzarella Flavor and Cheddar Flavor.

In some embodiments, the present vegan cheese optionally comprises one or more food coloring agents or dyes. Food coloring agents are generally helpful to make the vegan cheese more analogous to classic cheese such as cheddar cheese in color and appearance. Non-limiting examples food coloring agents include annatto, beta-carotene, cumin, curcumin, turmeric, achiote, saffron, paprika, or the combination thereof. Annatto is a natural yellow—orange coloring agent obtained from the plant Bixa orellana, which causes less toxicity and generally exhibits better biodegradability and compatibility with the environment than synthetic food coloring agents. Beta carotene is a natural red-orange coloring agent found in plants and fruits, especially carrots and colorful vegetables. Beta carotene is also an antioxidant beneficial to health. In some embodiments, the present vegan cheese comprises from about 0.1 wt. % to about 0.5 wt. % of annatto and beta-carotene.

In some embodiments, the present vegan cheese comprises a spice. Non-limiting examples of spices include achiote, paprika, turmeric, ginger, pepper (e.g., jalapeno, habanero, ghost, green, or red), peppercorn, garlic, onion, cardamom, cumin, curcumin, saffron, clove, fennel, fenugreek, nutmeg, mace, rosemary, anise, thyme, mustard, ajwain, cinnamon, or combinations thereof. In some embodiments, the present vegan cheese comprises pepper, wherein the pepper is from about 0.5 wt % to about 10 wt %, from about 1 wt % to about 8 wt %, or from about 2 wt % to about 5 wt % based on the total weight of the vegan cheese. Non-limiting examples of the pepper include jalapeno pepper and habanero pepper. In certain embodiments, the vegan cheese comprises paprika and turmeric, wherein the total content of the paprika and the turmeric is from about 0.01 wt. % to about 0.1 wt. %, from about 0.02 wt. % to about 0.08 wt. %, or from about 0.03 wt. % to about 0.05 wt. %, based on the total weight of the vegan cheese.

GMOs are organisms whose genetic material has been artificially modified by human interference using genetic engineering methods such as recombinant DNA to change their characteristics. Foods containing GMOs or made therefrom are disfavored by certain groups of consumers. In some embodiments, the present vegan cheese is substantially free or free from GMOs or part thereof.

An allergen is any substance (antigen), most often eaten or inhaled, that is recognized by the immune system and causes an allergic reaction. Some common foods such as nuts can be dangerous allergens and can cause serious allergic reaction to certain consumers. In some embodiments, the vegan cheese of the present disclosure is free from an allergen, wherein the allergen is selected from the group of dairy milk, egg, fish, crustacean, shellfish, nut, tree nut, peanut, soybean, and gluten.

In some aspects, the vegan cheese of the present disclosure relates to a cheese analogue made from the present vegan cheese. Cheese “analogue” or “replica” can be any non-dairy product that can be used in any role commonly served by traditional dairy cheese. An “analogue” or “replica” can be a product that shares visual, olfactory, textural or taste characteristics of cheese such that an ordinary human observer of the product is induced to think of traditional dairy cheese. For example, cheeses can be categorized into creamy, soft, semi-soft, medium-hard, semi-hard, and hard cheeses by hardness or firmness, which commonly depends on the water/moisture content, salts, and/or processing conditions. One skilled in the art is able to determine suitable ingredients and conditions in light of the present disclosure to arrive at vegan cheese analogues with desirable hardness. As non-limiting exemplary embodiments, the present cheese analogue can be Mozzarella cheese, Cheddar cheese, Parmesan cheese (Parmigiano-Reggiano cheese), Swiss cheese, Gruyère cheese, Feta cheese, Gouda cheese, Manchego cheese, Pecorino cheese, Brie cheese, or jack cheese.

### Food Products Using the Vegan Cheese Composition

In some aspects, the vegan cheese of the present disclosure relates to a cheese food product (cheese product hereafter) containing the present vegan cheese. The cheese product of the present disclosure is broadly defined as any food product containing the present vegan cheese or made therefrom. The cheese food product made from the present vegan cheese can be ready to serve in any form or shape including but not limited to block, cream, spread, stick, curd, nugget, whip, shred, and slice. The cheese products may be served to customers via food serving businesses such as food markets, grocery stores, restaurants, food shops, vending machines, etc. The cheese products may be packaged in bulk, or individually packaged as end products, or repackaged by distributers or food service businesses. Alternatively, the vegan cheese may be used as a source to make food products, which ultimately contain the vegan cheese. As non-limiting exemplary embodiments, the present food products can be aligot, almogrote, burrito, breakfast burrito, taco, pizza, pizza analogue, eggs, egg sandwich, pastry, pasta, lasagna, sandwich, burger, croque monsieur, cheeseburger, gratin, fondue, hot dog, waffle, sandwich, wrap, baked cheese, tortilla chip, cheese sauce, cheese bite, cheese condiment, cheese crisp, bagel and cream cheese, cheese soup, cheese salad, cheese and crackers, cheese bun, cheese dog, cheese fries, cheese toastie, cheese pudding, cheese puffs, cheese roll, cheese slaw, cheesecake, frico, fried cheese, cheese and fries, cheese pie, fromage fort, grilled cheese, lasagna, macaroni and cheese, cheese sausage, nachos, quesadilla, quesillo, quesito, raclette, rasabali, saganaki, pizza bites, pizza rolls, pizza petites, pizza bagels, mozzarella cheese sticks, frozen cauliflower breadsticks, frozen sweet potato breadsticks, or ziva.

In some embodiments, the present cheese product is a pizza comprising the present vegan cheese, a dough, a crust, one or more sauces, and one or more toppings. In some embodiments, the present pizza further comprises one or more ingredients selected from the group of oil, sweetener, flavoring agent, food additives, or combinations thereof. The present pizza may be uncooked, semi-finished, cooked, frozen, heated or re-heated, or ready-to-serve. The present pizza may be microwavable.

In some embodiments, the present cheese product is free from animal products and/or GMOs. In some embodiments, the present cheese product is free or substantially free from allergen, wherein the allergen is selected from the group of dairy milk, egg, fish, crustacean, shellfish, nut, tree nut, peanut, soybean, and gluten.

### Methods of Making the Vegan Cheese

In some aspects, the present disclosure relates to a method of making the vegan cheese. In some embodiments, the method comprises: (a) cooking a mixture of water and one or more plant milks at a temperature of about 30° C. to about 70° C., or from about 40° C. to about 60° C., or from about 45° C. to about 55° C.; (b) adding to the mixture one or more vegetables derived from Brassica, Brassica oleracea, or Brassicaceae with agitation; (c) cooking the mixture at a temperature of about 70 to about 100° C., or from about 80° C. to about 90° C., or from about 82° C. to about 88° C.; (d) cooling the mixture and letting it rest for at least about 5 days, at least about 7 days, at least about 10 days, at least about 12 days, at least about 14 days, or at least about 16 days, or from about 5 days to about 20 days, from about 6 days to about 21 days, from about 7 days to about 15 days, from about 8 days to about 12 days, or from about 9 days to about 11 days. The weight percentages of the raw materials described herein describe the weight percentages of the starting materials and the resulting finished cheese product. It is expected that during resting, a certain amount of water will be lost as the cheese sets, firms, or hardens. Thus the concentrations of the starting materials and the materials in the finished product are expected to be different. However, the amount of water lost is not expected to be significant enough to take the concentration of the materials outside of the ranges described herein.

In some embodiments, the method may further comprise adding one or more plant/vegetable oils in step (a). In some embodiments, the method may further comprise adding salt, one or more thickeners/stabilizers, and nutritional yeast in step (b). In some embodiments, the method may further comprise adding to the mixture a juice and natural vegan flavor with agitation between step (b) and (c). In some embodiments, the method may further comprise adding to the mixture one or more starches with agitation between step (b) and (c). In some embodiments, the method may further comprise adding to the mixture one or more additional ingredients with agitation, wherein the additional ingredient is selected from the group of an acidity regulator, an acid, an anticaking agent, an antifoaming agent, a coloring agent, an emulsifier, an enzyme or enzyme preparation, a flavoring agent, a spice, a gelling agent, a preservative, a nutritional supplement, a nutritional yeast, a nutraceutical, a carbohydrate, a vitamin or vitamin concentrate, a mineral, or combinations thereof.

In preferred embodiments of the present method, the plant milk is oat milk, pea milk, or combinations thereof; the one or more vegetables comprise cauliflower, preferably a cauliflower paste; the one or more thickeners/stabilizers comprises carrageenan and/or xanthan gum; the juice is a lemon juice; the one or more starches comprise corn starch and/or tapioca starch.

In preferred embodiments, the present method comprises: (a) cooking at a temperature of about 30° C. to about 70° C. a mixture of water, one or more plant milks selected from the group consisting of oat milk, pea milk, or combinations thereof, and one or more plant/vegetable oils; (b) adding to the mixture a cauliflower paste, salt, carrageenan and/or xanthan gum, and nutritional yeast with agitation; (c) adding to the mixture a lemon juice and a natural vegan flavor with agitation; (d) adding to the mixture one or more starches with agitation; (e) cooking the mixture at a temperature in a range from about 70° C. to about 100° C.; (f) cooling the mixture at about 3° C. to about 5° C. and letting it rest for about 5 days to about 21 days.

In general, the present method of making vegan cheeses may be carried out using standard food processing equipment and facilities. The cooking step(s) of the present method may comprise heating, agitating, stirring, or homogenizing the mixture continuously or intermittently. The temperature and time length of cooking step(s) may vary depending on the desired water content and/or hardness of the final vegan cheese products. A skilled person in the art will determine the suitable temperature and time length in light of the present disclosure to arrive at vegan cheese with desired characteristics. In some embodiments, the total cooking time is from about 10 minutes to about 50 minutes, or from about 15 minutes to about 40 minutes, or from about 20 minutes to about 30 minutes.

The adding step(s) of the present method may last for about 1 minute to about 20 minutes, or from about 2 minutes to about 10 minutes, or from about 4 minutes to about 6 minutes. The ingredients may be added separately, or simultaneously, or sequentially, or in portions, or instantaneously, with or without agitation.

After cooking the mixture containing all required ingredients, the mixture is cooled down to a desired temperature from about 0° C. to about 25° C. in about 2 hours to about 10 hours, or in about 3 hours to about 8 hours, or in about 4 hours to about 6 hours.

It is noted that the present method of making vegan cheeses comprises cooling the cooked mixture and letting it rest for at least about 5 days. In some embodiments, the resting step lasts for at least about 5 days, at least about 7 days, at least about 10 days, at least about 12 days, at least about 14 days, or at least about 16 days. In some embodiments, the cooling step lasts for about 5 days to about 21 days, from about 6 days to about 15 days, from about 7 days to about 14 days, from about 8 days to about 12 days, or from about 9 days to about 11 days. Comparatively, in a common process of making dairy cheese, the intermediate products comprising dairy components are usually rested for less than about 5 days to produce the finished dairy cheese. It was surprisingly found that a resting time for 5 days or longer resulted in vegan cheeses that have better texture, consistency, performance, and taste.

In some embodiments, the cooling temperature of the present method is about the room temperature, from about 15° C. to about 25° C. In other embodiments, the cooling temperature is a refrigerated temperature, from about 0° C. to about 15° C., from about 2° C. to about 10° C., from about 3° C. to about 8° C., or from about 3° C. to about 5° C.

In some embodiments, the mixture was cooled in a block form at a refrigerated controlled environment such as in a household or commercial refrigerator.

### EXAMPLES

The present disclosure will now be described with reference to specific examples, which should not be construed as in any way limiting.

### Example 1. Mozzarella Vegan Cheese

The starting raw materials according to an embodiment of the present disclosure are given in Table 1.

TABLE 1

| Component | Content (lb) | Wt. % |
|---|---|---|
| Water | 211 | 36.03% |
| Corn starch | 125 | 21.35% |
| Oat milk | 54 | 9.22% |
| Coconut oil | 100 | 8.54% |
| Tapioca starch | 50 | 8.54% |
| Canola oil | 50 | 8.54% |
| Salt | 15 | 2.56% |
| Cauliflower | 10 | 1.71% |
| Carrageenan | 7.5 | 1.28% |
| Xanthan gum | 5.7 | 0.97% |
| Lemon juice | 3.55 | 0.61% |
| Nutritional yeast | 3 | 0.51% |
| Natural vegan flavor | 0.8 | 0.14% |
| Total | 585.55 | 100.00% |

The Mozzarella-type vegan cheese was made according to the following steps: (1) a mixture of water, oat milk, canola oil, and coconut oil were made and cooked at 50° C. with agitation for about 5 minutes; (2) salt, cauliflower, carrageenan, xanthan gum, and nutritional yeast were added to the mixture, and the mixture was agitated for about 5 minutes; (3) lemon juice and natural vegan flavor were added to the mixture, and the mixture was agitated for about 3 minutes; (4) corn starch and tapioca starch were added into the mixture with agitation, (5) the mixture was cooked at about 85° C. for about 20 minutes to about 25 minutes; (6) the mixture was cooled down to about 3° C. to about 5° C. in about 5 hours; (7) the mixture was further rested at about 3° C. to about 5° C. in a refrigerator for about 10 days. The resulting Mozzarella-type vegan cheese has a cream-to-white appearance and has a moisture content of less than about 52%, about 2% to about 4% of salt, and a pH value of about 3.3 to about 3.7. The Mozzarella-type vegan cheese is free or substantially free from peanut, tree nut, milk, egg, fish, shellfish, soy, wheat. The Mozzarella-type vegan cheese does not use raw materials or produce finished product that contain genetically modified organism (GMO). Table 2 shows the nutritional profile of the finished Mozzarella-type vegan cheese.

TABLE 2
Nutritional profile of 100 grams of the finished
Mozzarella-type vegan cheese according to Example 1.

| | |
|---|---|
| Total Calories | 285.39 Kcal |
| Calories from fat | 144.34 Kcal |
| Calories from saturated | 92.27 Kcal |
| fat | |
| Total fat | 16.04 g |
| Saturated fat | 10.25 g |
| Polyunsaturated fat | 1.40 g |
| Monounsaturated fat | 3.59 g |
| Trans fat | 0.04 g |
| Cholesterol | 0.00 mg |
| Sodium | 765.22 mg |
| Potassium | 167.40 mg |
| Total carbohydrates | 34.46 g |
| Dietary fiber | 4.99 g |
| Sugars | 0.86 g |
| Added sugars | 0.72 g |
| Protein | 1.94 g |
| Calcium | 12.86 mg |
| Iron | 0.69 mg |
| Vitamin D | 0.06 μg |

### Example 2. Cheddar Vegan Cheese Raw Materials

The starting raw materials according to another embodiment of the present disclosure are given in Table 3.

TABLE 3

| Component | Content (lb) | Wt. % |
|---|---|---|
| Water | 211 | 36.03% |
| Corn starch | 125 | 21.30% |
| Oat milk | 54 | 9.20% |
| Coconut oil | 50 | 8.52% |
| Tapioca starch | 50 | 8.52% |
| Canola oil | 50 | 8.52% |
| Salt | 15 | 2.56% |
| Cauliflower | 10 | 1.71% |
| Carrageenan | 7.5 | 1.28% |
| Xanthan gum | 5.7 | 0.97% |
| Lemon juice | 3.55 | 0.61% |
| Nutritional yeast | 3 | 0.51% |
| Annatto Beta-carotene | 1 | 0.17% |
| Natural vegan flavor | 0.8 | 0.14% |
| Paprika | 0.1 | 0.02% |
| Turmeric | 0.1 | 0.02% |
| Total | 586.75 | 100.00% |

The Cheddar-type vegan cheese was made according to the following steps: (1) a mixture of water, oat milk, canola oil, and coconut oil were made and cooked at 50° C. with agitation for about 5 minutes; (2) salt, cauliflower, carrageenan, xanthan gum, and nutritional yeast were added to the mixture, and the mixture was agitated for about 5 minutes; (3) lemon juice, natural vegan flavor, annatto beta-carotene, paprika and turmeric were added to the mixture, and the mixture was agitated for about 3 minutes; (4) corn starch and tapioca starch were added into the mixture with agitation, (5) the mixture was cooked at about 85° C. for about 20 minutes to about 25 minutes; (6) the mixture was cooled down to about 3° C. to about 5° C. in about 5 hours; (7) the mixture was rested at about 3° C. to about 5° C. in a refrigerator for about 10 days.

The resulting Cheddar-type vegan cheese has a yellow-orange appearance, a shredded form, and has a moisture content of less than about 52%, about 2% to about 4% of salt, a pH value of about 3.3 to about 3.7. The Cheddar-type vegan cheese is free or substantially free from peanut, tree nut, milk, egg, fish, shellfish, soy, wheat. The Cheddar-type vegan cheese does not use raw materials or produce finished product that contains genetically modified organisms (GMOs). Table 4 shows the nutritional profile of the finished Cheddar-type vegan cheese.

TABLE 4
Nutritional profile of 100 grams of the finished
Cheddar-type vegan cheese according to Example 2.

| | |
|---|---|
| Total Calories | 279.92 Kcal |
| Calories from fat | 141.50 Kcal |
| Calories from saturated fat | 90.45 Kcal |
| Total fat | 15.72 g |
| Saturated fat | 10.05 g |
| Polyunsaturated fat | 1.37 g |
| Monounsaturated fat | 3.52 g |
| Trans fat | 0.04 g |
| Cholesterol | 0.00 mg |
| Sodium | 750.98 mg |
| Potassium | 217.89 mg |
| Total carbohydrates | 33.79 g |
| Dietary fiber | 4.97 g |
| Sugars | 0.85 g |
| Added sugars | 0.70 g |
| Protein | 1.91 g |
| Calcium | 12.69 mg |
| Iron | 0.83 mg |
| Vitamin D | 0.06 μg |

### Example 3. Habanero Vegan Cheese Composition

The starting raw materials according to another embodiment of the present disclosure are given in Table 5.

TABLE 5

| Component | Content (lb) | Wt. % |
|---|---|---|
| Water | 190 | 31.86% |
| Corn starch | 125 | 20.96% |
| Oat milk | 70 | 11.74% |
| Coconut oil | 50 | 8.38% |
| Tapioca starch | 50 | 8.38% |
| Canola oil | 50 | 8.38% |
| Salt | 15 | 2.52% |
| Cauliflower | 10 | 1.68% |
| Carrageenan | 7.5 | 1.26% |
| Xanthan gum | 5.7 | 0.96% |
| Lemon juice | 3.55 | 0.60% |
| Nutritional yeast | 3 | 0.50% |
| Natural vegan flavor | 1.6 | 0.27% |
| Habanero pepper | 15 | 2.52% |
| Total | 596.35 | 100.00% |

The Habanero-type vegan cheese was made according to the following steps: (1) a mixture of water, oat milk, canola oil, and coconut oil were made and cooked at 50° C. with agitation for about 5 minutes; (2) salt, cauliflower, carrageenan, xanthan gum, and nutritional yeast were added to the mixture, and the mixture was agitated for about 5 minutes; (3) lemon juice, natural vegan flavor, and Habanero pepper were added to the mixture, and the mixture was agitated for about 3 minutes; (4) starch was added into the mixture with agitation, (5) the mixture was cooked at about 85° C. for about 20 minutes to about 25 minutes; (6) the mixture was cooled down to about 3° C. to about 5° C. in about 5 hours; (7) the mixture was further rested at about 3° C. to about 5° C. in a refrigerator for about 10 days.

### Example 4. Pepper Jack Vegan Cheese Composition

The starting raw materials according to another embodiment of the present disclosure are given in Table 6.

TABLE 6

| Component | Content (lb) | Wt. % |
|---|---|---|
| Water | 190 | 31.34% |
| Corn starch | 125 | 20.62% |
| Oat milk | 70 | 11.54% |
| Coconut oil | 50 | 8.25% |
| Tapioca starch | 50 | 8.25% |
| Canola oil | 50 | 8.25% |
| Salt | 15 | 2.47% |
| Cauliflower | 10 | 1.65% |
| Carrageenan | 7.5 | 1.24% |
| Xanthan gum | 5.7 | 0.94% |
| Lemon juice | 3.55 | 0.59% |
| Nutritional yeast | 3 | 0.49% |
| Natural vegan flavor | 1.6 | 0.26% |
| Jalapeno pepper | 25 | 4.12% |
| Total | 606.35 | 100.00% |

The Pepper Jack-type vegan cheese was made according to the following steps: (1) a mixture of water, oat milk, and plant oil were made and cooked at 50° C. with agitation for about 5 minutes; (2) salt, cauliflower, carrageenan, xanthan gum, and nutritional yeast were added to the mixture, and the mixture was agitated for about 5 minutes; (3) lemon juice, natural vegan flavor, and Jalapeno pepper were added to the mixture, and the mixture was agitated for about 3 minutes; (4) starch was added into the mixture with agitation, (5) the mixture was cooked at about 85° C. for about 20 minutes to about 25 minutes; (6) the mixture was cooled down to about 3° C. to about 5° C. in about 5 hours; (7) the mixture was further rested at about 3° C. to about 5° C. in a refrigerator for about 10 days.

### Example 5. Parmesan Vegan Cheese Composition

The starting raw materials according to another embodiment of the present disclosure are given in Table 7.

TABLE 7

| Component | Content (lb) | Wt. % |
|---|---|---|
| Water | 145 | 27.02% |
| Corn starch | 75 | 13.98% |
| Oat milk | 60 | 11.18% |
| Potato starch | 100 | 18.64% |
| Pea protein | 55 | 10.25% |
| Coconut oil | 35 | 6.52% |
| Canola oil | 30 | 5.59% |
| Salt | 10 | 1.86% |
| Carrageenan | 5 | 0.93% |
| Xanthan gum | 5 | 0.93% |
| Lemon juice | 3.55 | 0.66% |
| Nutritional yeast | 5 | 0.93% |
| Natural vegan flavor | 8 | 1.49% |
| Total | 536.55 | 100.00% |

The Parmesan-type vegan cheese was made according to the following steps: (1) a mixture of water, oat milk, canola oil, and coconut oil were made and cooked at 50° C. with agitation for about 5 minutes; (2) salt, pea protein, carrageenan, xanthan gum, and nutritional yeast were added to the mixture, and the mixture was agitated for about 5 minutes; (3) lemon juice and natural vegan flavor were added to the mixture, and the mixture was agitated for about 3 minutes; (4) starch was added into the mixture with agitation, (5) the mixture was cooked at about 85° C. for about 20 minutes to about 25 minutes; (6) the mixture was cooled down to about 3° C. to about 5° C. in about 5 hours; (7) the mixture was further rested at about 3° C. to about 5° C. in a refrigerator for about 10 days.

The resulting Parmesan-type vegan cheese has a cream-to-white appearance and has a moisture content of less than about 52%, about 2% to about 4% of salt, and a pH value of about 3.3 to about 3.7. The Parmesan-type vegan cheese is free or substantially free from peanut, tree nut, milk, egg, fish, shellfish, soy, wheat. The Parmesan-type vegan cheese does not use raw materials or produce finished product that contains genetically modified organisms (GMO). Table 8 shows the nutritional profile of the finished Parmesan-type vegan cheese.

TABLE 8
Nutritional profile of 100 grams of the
finished Parmesan-type vegan cheese
according to Example 5.

| | |
|---|---|
| Total Calories | 276.18 Kcal |
| Calories from fat | 155.18 Kcal |
| Calories from saturated fat | 102.51 Kcal |
| Total fat | 17.24 g |
| Saturated fat | 11.39 g |
| Trans fat | 0.04 g |
| Cholesterol | 0.00 mg |
| Sodium | 1242.95 mg |
| Potassium | 138.69 mg |
| Total carbohydrates | 27.75 g |
| Dietary fiber | 3.05 g |
| Sugars | 0.03 g |
| Added sugars | 0.00 g |
| Protein | 0.30 g |
| Calcium | 3.90 mg |
| Iron | 0.59 mg |
| Vitamin D | 0.06 μg |

### Example 6. Characterization of the Vegan Cheese Products

A test for measuring the stretchability of cheese was developed by adapting a texture-profile analyzer to pull strands of cheese upwards from a reservoir of melted cheese. The maximum load, obtained as the probe was lifted through the cheese, was defined as melt strength (F(M)). The distance to which cheese strands were lifted was defined as stretch length (SL). The load exerted on the probe as the strands of cheese were being stretched was defined as stretch quality (SQ). Tables 9-10 summarize the results of the stretchability and color tests.

TABLE 9
Stretchability of various vegan cheese examples
according to the present disclosure.

| Cheese | F_{M} (g) | SQ₅ (g) | SQ₂₀ (g) | SL (cm) |
|---|---|---|---|---|
| 60° C. | | | | |
| Mozzarella-type | 258 ± 15 | 111 ± 13 | 28 ± 2 | 29 ± 1 |
| Parmesan-type | 255 ± 20 | 54 ± 3 | 15 ± 3 | 23 ± 0 |
| Cheddar-type | 237 ± 16 | 87 ± 10 | 24 ± 6 | 26 ± 1 |
| Habanero-type | 213 ± 18 | 93 ± 4 | 29 ± 4 | 25 ± 0 |
| 70° C. | | | | |
| Mozzarella-type | 105 ± 4 | 25 ± 2 | 15 ± 1 | 29 ± 0 |
| Parmesan-type | 88 ± 17 | 12 ± 3 | 8 ± 1 | 23 ± 1 |
| Cheddar-type | 92 ± 14 | 18 ± 0 | 10 ± 1 | 30 ± 0 |
| Habanero-type | 83 ± 15 | 22 ± 3 | 13 ± 3 | 28 ± 0 |
| 80° C. | | | | |
| Mozzarella-type | 53 ± 2 | 14 ± 2 | 10 ± 1 | 29 ± 0 |
| Parmesan-type | 50 ± 8 | 9 ± 1 | 6 ± 1 | 18 ± 10 |
| Cheddar-type | 49 ± 7 | 10 ± 0 | 8 ± 1 | 27 ± 1 |
| Habanero-type | 54 ± 3 | 13 ± 3 | 9 ± 0 | 29 ± 0 |
| 90° C. | | | | |
| Mozzarella-type | 53 ± 2 | 17 ± 2 | 14 ± 1 | 28 ± 0 |
| Parmesan-type | 46 ± 12 | 3 ± 0 | 2 ± 1 | 3 ± 1 |
| Cheddar-type | 52 ± 3 | 15 ± 1 | 12 ± 0 | 22 ± 1 |
| Habanero-type | 50 ± 4 | 14 ± 3 | 11 ± 2 | 21 ± 1 |

F_{M} means melt strength (FM); SQ₅ means stretch quality at 5 cm; SQ₂₀ means stretch quality at 20 cm; and SL means stretch length.

TABLE 10
Melt strength and color of various vegan cheese
examples according to the present disclosure.

| | | | Color according to |
|---|---|---|---|
| | Melt | Fork test | National Cheese |
| Vegan | distance | distance | Institute Cheese Color |
| cheese | (cm) | (cm) | Standards |
| Mozzarella-type | 15.7 ± 2.2 | 11.2 ± 0.6 | 2 |
| Parmesan-type | 6.1 ± 1.1 | 6.2 ± 0.5 | 4 |
| Cheddar-type | 14.2 ± 1.4 | 9.9 ± 1.0 | 8 |
| Habanero-type | 13.3 ± 1.8 | 10.4 ± 1.3 | 3 |

As required, exemplary-only embodiments of the present application are disclosed herein; however, it is to be understood that the disclosed embodiments are merely exemplary of the present disclosure, which may be embodied in various and/or alternative forms. Specific composition or process details disclosed herein are not to be interpreted as limiting, but merely as a basis for the claims and as a representative basis for teaching one skilled in the art to variously employ the present disclosure in virtually any appropriately detailed processes. Aspects, advantages and/or other features of the exemplary embodiment of the present disclosure are apparent in view of the detailed description, which discloses various non-limiting embodiments of the invention. In describing exemplary embodiments, specific terminology is employed for the sake of clarity. However, the embodiments are not intended to be limited to this specific terminology. It is to be understood that each specific portion includes all technical equivalents that operate in a similar manner to accomplish a similar purpose.

As used herein, “weight percent,” “wt %, “percent by weight,” “% by weight,” and variations thereof refer to the concentration of a substance as the weight of that substance divided by the total weight of the composition and multiplied by 100. It is understood that, as used here, “percent,” “%,” and the like are intended to be synonymous with “weight percent,” “wt %”, etc.

As used herein, “lb” represents pound, and one pound equals to 453.59 grams. The unit of temperature used herein is degree Celsius (° C.).

The term “about” is used in conjunction with numeric values to include normal variations in measurements as expected by persons skilled in the art, and is understood have the same meaning as “approximately” and to cover a typical margin of error, such as +10% of the stated value. The term “about” also encompasses amounts that differ due to different equilibrium conditions for a composition resulting from a particular initial composition. Whether or not modified by the term “about,” the claims include equivalents to the quantities.

It should be noted that, as used in this specification and the appended claims, the singular forms “a,” “an,” and “the” include plural referents unless the content clearly dictates otherwise. Thus, for example, reference to a composition containing “a compound” includes having two or more compounds that are either the same or different from each other. It should also be noted that the term “or” is generally employed in its sense including “and/or” unless the content clearly dictates otherwise.

In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

The term “substantially free” may refer to any component that the composition of the disclosure lacks or mostly lacks. When referring to “substantially free” it is intended that the component is not intentionally added to compositions of the disclosure. Use of the term “substantially free” of a component allows for trace amounts of that component to be included in compositions of the disclosure because they are present in another component. However, it is recognized that only trace or de minimus amounts of a component will be allowed when the composition is said to be “substantially free” of that component. Moreover, the term if a composition is said to be “substantially free” of a component, if the component is present in trace or de minimus amounts it is understood that it will not affect the effectiveness of the composition. It is understood that if an ingredient is not expressly included herein or its possible inclusion is not stated herein, the disclosure composition may be substantially free of that ingredient. Likewise, the express inclusion of an ingredient allows for its express exclusion thereby allowing a composition to be substantially free of that expressly stated ingredient.

As will be readily apparent to those skilled in the art, the present embodiments may be produced in other specific forms without departing from its essential characteristics. The present embodiments are, therefore, to be considered as merely illustrative and not restrictive, the scope of the subject matter being indicated by the claims rather than the foregoing description, and all changes which come within therefore intended to be embraced therein. Many variations, modifications, additions, and improvements are possible. More generally, embodiments in accordance with the present disclosure have been described in the context of preferred embodiments. Functionalities may be separated or combined in procedures differently in various embodiments of the disclosure or described with different terminology. These and other variations, modifications, additions, and improvements may fall within the scope of the disclosure as defined in the appended claims.

We claim:

1. A vegan cheese comprising:
a plant milk, wherein the plant milk is an oat milk, a pea milk, or combination thereof;
one or more vegetables derived from Brassica, Brassica oleracea, or Brassicaceae; and
water,
wherein the vegan cheese is substantially free from animal products.

2. The vegan cheese of claim 1, wherein the plant milk is of about 3 wt. % to about 20 wt. % based on the total weight of the vegan cheese.

3. The vegan cheese of one of claims 1, wherein the one or more vegetables comprise cauliflower.

4. The vegan cheese of claim 3, wherein the cauliflower is of about 0.1 wt. % to about 5 wt. % based on the total weight of the vegan cheese.

5. The vegan cheese of claim 1, further comprising from about 10 wt. % to about 50 wt. % of a starch selected from the group of corn starch, wheat starch, maize starch, cassava starch, tapioca starch, rice starch, potato starch, sweet potato starch, pea starch, or combinations thereof.

6. The vegan cheese claim 1, further comprising one or more plant/vegetable oils.

7. The vegan cheese claim 1, further comprising one or more additional ingredients selected from the group of an acidity regulator, an acid, an anticaking agent, an antifoaming agent, a coloring agent, an emulsifier, an enzyme or enzyme preparation, a flavoring agent, a spice, a gelling agent, a preservative, a thickener, a stabilizer, a salt, a nutritional supplement, a nutritional yeast, a nutraceutical, a juice, a carbohydrate, a vitamin or vitamin concentrate, a mineral, or combinations thereof.

8. The vegan cheese of claim 7, wherein the thickener or stabilizer is selected from the group of cellulose, polysaccharide, polypropylene glycol, alginate, sodium alginate, xanthan gum, guar gum, carrageenan, konjac flour, locus bean gum, or combinations thereof.

9. The vegan cheese of claim 7, wherein the juice comprises a lemon juice.

10. The vegan cheese of claim 7, wherein the flavoring agent comprises a natural vegan flavor.

11. The vegan cheese of claim 7, wherein the coloring agent comprises annatto, or beta-carotene, or combinations thereof.

12. The vegan cheese of claim 7, wherein the spice is selected from the group of paprika, turmeric, ginger, pepper, garlic, onion, cardamom, cumin, clove, fennel, fenugreek, nutmeg, mace, rosemary, anise, thyme, mustard, ajwain, cinnamon, or combinations thereof.

13. The vegan cheese of claim 1, wherein the vegan cheese is substantially free from genetically-modified organisms (GMOs) or part/product thereof.

14. The vegan cheese of claim 1, wherein the vegan cheese is a mozzarella cheese analogue.

15. The vegan cheese of claim 1, wherein the vegan cheese is a cheddar cheese analogue.

16. A food product comprising a vegan cheese, the vegan cheese comprising:
a plant milk, wherein the plant milk is an oat milk, a pea milk, or combination thereof;
one or more vegetables derived from Brassica, Brassica oleracea, or Brassicaceae; and
water,
wherein the vegan cheese is substantially free from animal products.

17. The food product of claim 16, wherein the food product is cheese cream, cheese spread, cheese stick, cheese curd, cheese shred, cheese slide, aligot, almogrote, burrito, taco, pizza, pizza analogue, pasta, lasagna, sandwich, burger, croque monsieur, cheeseburger, gratin, fondue, hot dog, waffle, sandwich, wrap, baked cheese, tortilla chip, cheese sauce, cheese bite, cheese condiment, cheese crisp, bagel and cream cheese, cheese soup, cheese salad, cheese and crackers, cheese bun, cheese dog, cheese fries, cheese toastie, cheese pudding, cheese puffs, cheese roll, cheese slaw, cheesecake, frico, fried cheese, cheese and fries, cheese pie, fromage fort, grilled cheese, lasagna, macaroni and cheese, cheese sausage, nachos, quesadilla, quesillo, quesito, raclette, rasabali, saganaki, pizza bites, pizza rolls, pizza petites, pizza bagels, mozzarella cheese sticks, frozen cauliflower breadsticks, frozen sweet potato breadsticks, or ziva.

18. A pizza comprising
a vegan cheese comprising:
a plant milk, wherein the plant milk is an oat milk, a pea milk, or combination thereof;
one or more vegetables derived from Brassica, Brassica oleracea, or Brassicaceae; and
water;
dough, one or more sauces, and optionally, one or more toppings wherein the vegan pizza is substantially free from animal products; and.

19. The pizza of claim 18, further comprising one or more ingredients selected from the group of oil, sweetener, flavoring agent, food additives, or combinations thereof.

20. The pizza of claim 18, wherein the pizza is uncooked, semi-finished, or cooked.

21. The pizza of claim 18, wherein the pizza is frozen, heated or re-heated, or ready-to-serve.

22. A method of making a vegan cheese comprising:
(a) cooking a mixture comprising water and one or more plant milks at a temperature from about 30° C. to about 70° C.;
(b) adding to the mixture one or more vegetables derived from Brassica, Brassica oleracea, or Brassicaceae with agitation;
(c) cooking the mixture at a temperature of about 70° C. to about 100° C.;
(d) cooling the mixture; and
(e) resting the mixture for at least about 5 days.

23. The method of claim 22, wherein the one or more plant milks comprise oat milk, or pea milk, or combinations thereof.

24. The method of claim 22, wherein the one or more vegetables comprises cauliflower paste.

25. The method of claim 22, wherein the total cooking time is from about 10 minutes to about 50 minutes.

26. The method of claim 22, wherein cooling the mixture is performed at about 0° C. to about 15° C.

27. A method of making a vegan cheese comprising:
(a) cooking at a temperature of about 30° C. to about 70° C. a mixture comprising water, one or more plant milks selected from the group consisting of oat milk, pea milk, or combinations thereof, and one or more plant oils;
(b) adding to the mixture a cauliflower paste, salt, a gum, and nutritional yeast with agitation;
(c) adding to the mixture a lemon juice and a natural vegan flavor with agitation;
(d) adding to the mixture one or more starches with agitation;
(e) cooking the mixture at a temperature in a range from about 70° C. to about 100° C.;
(f) cooling the mixture at room temperature; and
(g) resting the mixture for at least about 5 days.
